(19) United States
(12) Patent Application Publication
(10) Pub. No.: US 2003/0226435 A1
(43) Pub. Date: Dec. 11, 2003

(54) Slitter for slitting a wide sheet into narrow strips and a controller and a controlling method for the slitter

(75) Inventor: Masashi Aoki, Kanagawa-ken (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/443,010

(22) Filed: May 22, 2003

Related U.S. Application Data
(63) Continuation-in-part of application No. 08/808,181, filed on Feb. 28, 1997, now abandoned.

(30) Foreign Application Priority Data
Mar. 8, 1996 (JP) 51511/1996

(51) Int. Cl. B26D 5/06

(52) U.S. Cl. 83/34; 700/186; 83/558

(57) ABSTRACT

Slitting knife arrangement in a slitter is controlled by a controller by use of a fixed common program without changing the program when a new setting of slitting knife arrangement is specified. To derive a series of signals to move slitting knives in the slitter, the controller requires input of a next slitting width and the number of slitting knives to be used next. In addition to the two input parameters, additional parameters of current positions of the slitting knives and the number of slitting knives currently used can be acquired from memory in the controller for deriving the series of signals.

### BACKGROUND OF THE INVENTION

1. Field of the Invention

This invention relates to a method of controlling arrangements of slitting knives to change the slitting width in a slitter for slitting a wide sheet into a plurality of narrow strips by a plurality of slitting knives arranged at predetermined intervals, and more particularly to a method of controlling arrangements of such slitting knives which can easily provide an additional arrangement of the slitting knives. This invention also relates to a slitter and controller for the slitter which can easily meet the above requirement.

2. Description of the Related Art

There has been known a slitter for slitting a wide sheet into a plurality of narrow strips by use of a plurality of slitting knives mounted on a shaft extending in a direction substantially normal to the direction in which the wide sheet is fed, as disclosed, for instance, in Japanese Unexamined Patent Publication Nos. 63(1988)-134193 and 3(1991)-245995.

In a slitter of this type, the slitting width can be changed by changing the arrangement of the slitting knives by moving the slitting knives along the shaft so that the spaces among the knives vary. Recently there has been proposed a slitter in which the arrangement of the slitting knives can be automatically changed and examples of systems for controlling the arrangement of the slitting knives are disclosed in the patent publications described above.

As disclosed in the patent publications, when the arrangement of the knives is automatically switched, generally the knives are directly moved from a position for a given slitting width to a position for another slitting width. For example, assuming that each slitting knife is set in positions a, b and c for respective slitting widths A, B and C, any change in slitting width can be dealt with by controlling the knife moving means to be able to move each knife from any one of the positions a, b and c to either of the other two positions.

As means for controlling the knife moving means, a controller storing therein six programs for moving each knife from position a to position b, from position a to position c, from position b to position c, from position b to position a, from position c to position a and from position c to position b, can be suitably employed.

However in such a system where each of the slitting knives is moved directly from one position to another using a selected one of a plurality of predetermined programs, there is a problem that it is difficult to provide an additional arrangement of the slitting knives.

That is, assuming that M sorts of slitting widths are required, programs for moving the slitting knives from M sorts of positions to other (M−1) sorts of positions are necessary, and accordingly M·(M−1) sets of programs are necessary in total. When one slitting width is to be added, (M+1)·M sets of programs become necessary and the number of programs to be created is (M+1)·M−M·(M−1) (=2M).

For example, in the case of a slitter for slitting photographic materials, the sorts of slitting widths sometimes number 40 and when one sort of slitting width is to be added, another 80 sets of programs for controlling the knife moving means must be created. Further when new programs are created, control actions based on the programs must be checked and the accuracy of each control action must be checked. Thus setting an additional knife arrangement has conventionally required a long time.

### SUMMARY OF THE INVENTION

In view of the foregoing observations and description, an object of the present invention is to provide a method of controlling arrangements of slitting knives which can easily provide an additional arrangement of the slitting knives. It is also an object of the present invention to provide a slitter itself or a controller for the slitter which can easily provide an additional arrangement of the slitting knives.

That is, a controller according to the present invention is a controller for controlling slitting knife arrangements in a slitter for slitting a wide sheet into a plurality of narrow strips by use of a plurality of slitting knives mounted on one or more shafts each extending in a direction substantially normal to a direction in which the wide sheet is fed, comprising: input means for specifying a next slitting width and the number of slitting knives to be used next as input parameters; and arithmetic means which receives the next slitting width and the number of slitting knives to be used next from the input means, and operates to generate a series of signals for moving a plurality of slitting knives to respective positions that effect slitting with the next slitting width and the number of slitting knives to be used next by use of a fixed common program.

In the above controller according to the present invention, the series of signals may be such signals that move a plurality of slitting knives in such an order that movement of each of a plurality of slitting knives is not interfered by the others of a plurality of slitting knives.

Further, in the above controller according to the present invention, the fixed common program can be structured to generate the series of signals based on the next slitting width, the number of slitting knives to be used next, current positions of a plurality of slitting knives and the number of slitting knives currently used. In that case, the controller may further comprise memory for storing the current positions of a plurality of slitting knives and the number of slitting knives currently used, so that the arithmetic means can acquire the current positions of a plurality of slitting knives and the number of slitting knives currently used from the memory.

Similarly, a slitter according to the present invention is a slitter for slitting a wide sheet into a plurality of narrow strips comprising: a plurality of slitting knives mounted on one or more shafts each extending in a direction substantially normal to a direction in which the wide sheet is fed; input means for specifying a next slitting width and the number of slitting knives to be used next as input parameters; arithmetic means which receives the next slitting width and the number of slitting knives to be used next from the input means, and operates to generate a series of signals for moving a plurality of slitting knives to respective positions that effect slitting with the next slitting width and the number of slitting knives to be used next by use of a fixed common program; and knife moving means for moving each of a plurality of slitting knives in the manner specified by the series of signals.

Further, a controlling method according to the present invention is a method for controlling slitting knife arrangements in a slitter for slitting a wide sheet into a plurality of narrow strips by use of a plurality of slitting knives mounted on one or more shafts each extending in a direction substantially normal to a direction in which the wide sheet is fed, comprising the steps of: specifying a next slitting width and the number of slitting knives to be used next as input parameters; generating a series of signals for moving a plurality of slitting knives to respective positions that effect slitting with the next slitting width and the number of slitting knives to be used next by use of a fixed common program; and moving each of a plurality of slitting knives in the manner specified by the series of signals.

In accordance with the present invention, setting of an additional arrangement of the slitting knives is facilitated by executing a fixed common program for controlling the knife moving means in combination with the slitting operation.

That is, in accordance with the present invention, addition of one slitting knife arrangement to M sorts of arrangements can be realized by calculating M sets of position information and moving order information for moving the slitting knives from the positions for the new arrangement to the positions for the M sorts of arrangements, and M sets of position information and moving order information for moving the slitting knives from the positions for the M sorts of arrangements to the positions for the new arrangement. That is, the addition of one slitting knife arrangement to M sorts of arrangements can be realized by only calculating 2M sets of position information and moving order information without changing the program itself or adding new programs.

Calculation of 2M sets of position information and moving order information by use of a fixed common program is much easier than the creation of 2M sets of programs for moving the slitting knives. Thus, according to the present invention, setting of an additional arrangement of the slitting knives is facilitated.

Specifically, it takes about one day to add a slitting knife arrangement to forty sorts of arrangements in the conventional method. In contrast, according to the present invention, the time can be shortened to about one hour.

### BRIEF DESCRIPTION OF THE DRAWINGS

FIG. 1 is a schematic side view showing an example of a slitter to which the method of the present invention is applied.

FIG. 2 is a schematic front view showing a part of the slitter.

FIG. 3 is a view for illustrating a procedure of switching arrangement of the slitting knives in accordance with an embodiment of the present invention.

FIG. 4 is a flow chart for illustrating initialization of the positions of the slitting knives.

FIGS. 5 to 8 are flow charts for illustrating the processing to obtain positions to which the respective slitting knives are to be moved and the order in which the slitting knives are moved, in accordance with an embodiment of the present invention.

FIG. 9 is a view for illustrating a procedure of switching arrangement of the slitting knives in accordance with an alternative embodiment of the present invention.

### DESCRIPTION OF THE PREFERRED EMBODIMENTS

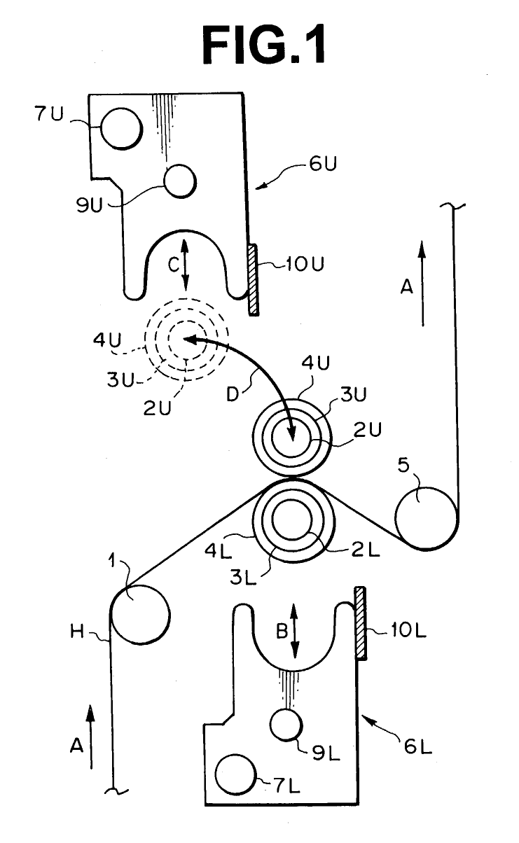

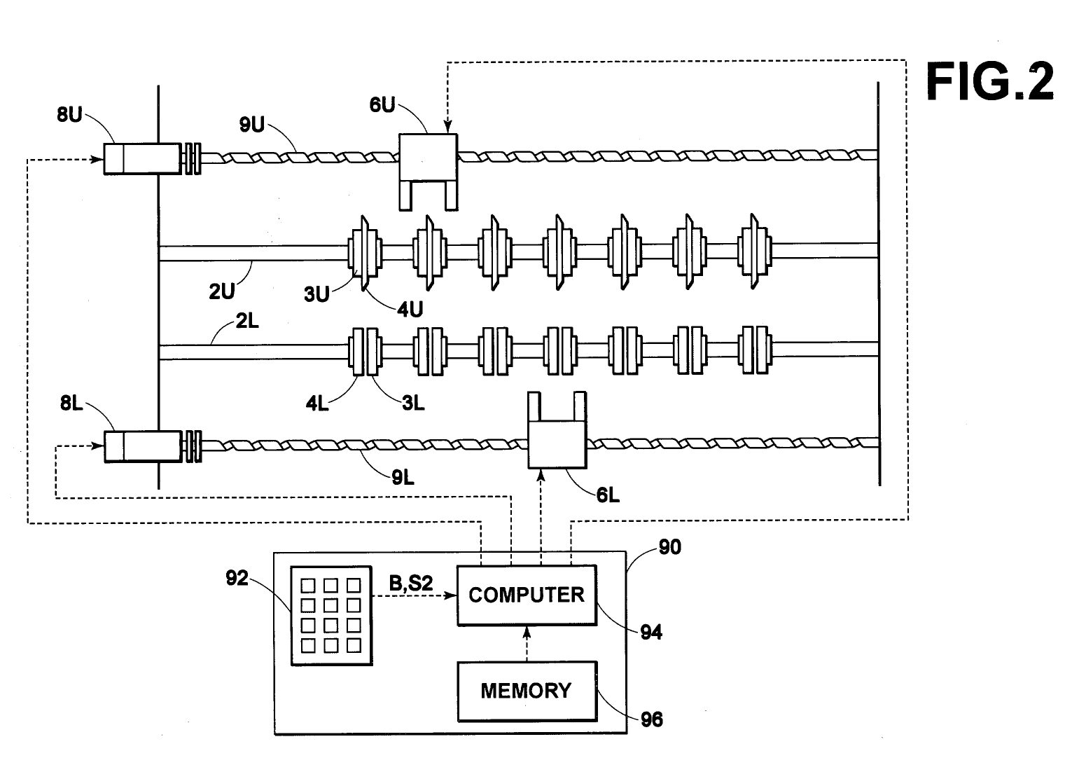

A method of controlling the arrangements of slitting knives will be described, hereinbelow. The method of the present invention is applied to, for instance, a slitter shown in FIGS. 1 and 2. In FIGS. 1 and 2, a slitter comprises a pair of pass rollers 1 and 5 around which a wide sheet H in a continuous length such as raw web of photographic paper is passed, a feeding means (not shown) for feeding the wide sheet H in the direction of arrow A in FIG. 1, upper and lower shafts 2U and 2L which extend substantially normal to the feeding direction of the wide sheet H respectively above and below thereof, a plurality of upper and lower knife holders 3U and 3L (e.g., seven each) respectively mounted on the upper and lower shafts 2U and 2L to be movable along the shafts, and a plurality of upper and lower knives 4U and 4L respectively mounted on the upper and lower knife holders 3U and 3L.

A lower knife moving mechanism 6L is disposed below the lower shafts 2L to be movable up and down in the direction of arrow B. The upper shaft 2U is rotated by a rotating mechanism (not shown) in the direction of arrow D between a slitting position shown by the solid line in FIG. 1 and a retracted position shown by the broken line. An upper knife moving mechanism 6U is disposed above the retracted position of the upper shaft 2U to be movable up and down in the direction of arrow C.

The lower knife moving mechanism 6L is fitted on a guide shaft 7L, extending in parallel to the upper and lower shafts 2U and 2L, to be slidable along the guide shaft 7L. The lower knife moving mechanism 6L is in mesh with a threaded shaft 9L and is slid back and forth along the guide shaft 7L in response to rotation of a motor 8L. Similarly the upper knife moving mechanism 6U is fitted on a guide shaft 7U, extending in parallel the upper and lower shafts 2U and 2L, to be slidable along the guide shaft 7U and at the same time is in mesh with a threaded shaft 9U and is slid back and forth along the guide shaft 7U in response to rotation of a motor 8U. In FIG. 2, the guide shafts 7U and 7L are omitted.

A holder detecting means 10T for detecting the lower knife holder 3L is mounted on the lower knife moving mechanism 6L and a holder detecting means 10U for detecting the upper knife holder 3U is mounted on the upper knife moving mechanism 6U. The holder detecting means 10T and 10U may comprise, for instance, a photoelectric tube, a contactless switch or a limit switch.

The upper knives 4U are arranged at regular intervals on the upper shaft 2U and the lower knives 4L are disposed in contact with the corresponding upper knives 4U in said slitting position. While the upper and lower shafts 4U and 4L are rotated to rotate the upper and lower knives 4U and 4L, the wide sheet H is fed between the upper and lower knives 4U and 4L, whereby the wide sheet H is slit into a plurality of narrow strips.

The slitting width of the wide sheet H or the widths of the strips are determined by the intervals between the cutters each formed by the upper and lower knives 4U and 4L. Accordingly by switching the arrangements of the cutters so that the intervals between the cutters change, the slitting widths can be changed. The arrangements of the cutters are basically switched in the following manner.

When the arrangements of the upper knives 4U are switched, the upper shaft 2U is rotated to the retracted position and then the motor 8U is energized to rotate the threaded shaft 9U, thereby moving the upper knife moving mechanism 6U in the longitudinal direction of the threaded shaft 9U. A control unit 90 which may comprise, for instance a microcomputer, controls the motor 8U to control the movement of the upper knife moving mechanism 6U. When the holder detecting means 10U of the upper knife moving mechanism 6U detects one of the upper knife holders 3U, that is, when the upper knife moving mechanism 6U comes to be aligned with one of the upper knife holders 3U, the control unit 90 stops the motor 8U.

Then the upper knife moving mechanism 6U is moved to a predetermined position close to the upper shaft 2U and is brought into engagement with the upper knife holder 3U. Then the upper knife moving mechanism 6U releases the upper knife holder 3U from the upper shaft 2U and the control unit 90 drives the motor 8U to move the upper holder 3U along the upper shaft to a predetermined position by way of the upper knife moving mechanism 6U. Thereafter, the upper knife moving mechanism 6U fixes the upper knife holder 3U (and the upper knife 4U) to a desired position on the upper shaft 2U, and then moves away from the upper shaft 2U. The other upper knife holders 3U are moved along the upper shaft 2U and fixed to desired positions on the upper shaft 2U in the same manner.

The operation of the upper knife moving mechanism 6U described above is also controlled by the control unit 90. The mechanism for releasably fixing the upper knife holders 3U to the upper shaft 2U and the mechanism for fixing and releasing the upper knife holders 3U to and from the upper shaft 2U may comprise, for instance, those disclosed in Japanese Unexamined Patent Publication No. 3(1991)-245995.

The arrangements of the lower knives 4L are switched in the same manner except that the lower shaft 2L is not moved and accordingly will not be described here.

A method of controlling the arrangements of slitting knives to switch the arrangements of the cutters from one arrangement (the current arrangement) to another arrangement (next arrangement) in accordance with an embodiment of the present invention will be described, hereinbelow. The method of the present embodiment can be applied to the slitter shown in FIGS. 1 and 2. As switching of positions of the lower knives 4L may be made in the similar manner, the description below will be made only on the switching of positions of the upper knives 4U.

In the present embodiment, an instruction to switch slitting widths is given with input of the next slitting width and the number of slitting knives to be used next through a numeric pad 92 as input means of the control unit 90. A computer 94 as arithmetic means in the control unit 90 acquires absolute positions X(N) of the upper knives 4U in the current positions (positions for the current slitting width) from memory 96, calculates the absolute positions Y(N) of the upper knives 4U in the next positions (positions for the next slitting width), and allocates those absolute positions X (N) and Y (N) to appropriate blanks in a fixed format of program 20 shown below.

Program 20

\mathring{1} To move the upper knife holder 3U in position W(1) to position Z(1).

\mathring{2} To move the upper knife holder 3U in position W(2) to position Z(2)

\mathring{3} To move the upper knife holder 3U in position W(3) to position Z(3).

\mathring{4} To move the upper knife holder 3U in position W(4) to position Z(4).

\mathring{5} To move the upper knife holder 3U in position W(5) to position Z(5).

\mathring{6} To move the upper knife holder 3U in position W(6) to position Z(6).

\mathring{7} To move the upper knife holder 3U in position W(7) to position Z(7).

In the above fixed format of program 20, W(N) and Z(N) stand for the blanks. That is, the absolute positions X(N) are allocated to W(N) and the absolute positions Y(N) are allocated to Z(N) in such an order that movement of each slitting knife is not interfered by the other slitting knives. The above calculation and allocation by the computer 94 are carried out using a fixed common program preprogrammed in the computer 94.

The control unit 90 can be either of an integrated unit included in the slitter or a separated unit connected to the slitter via a cable or the like. In addition, although the entire fixed common program is stored in the same control unit 90 in the present embodiment, it is also possible to allot divided portions of the fixed common program to different units or apparatus. For example, it is possible to store the allocating portion of the fixed common program in a control chip or memory within the slitter itself, while storing only the calculating portion of the fixed common program in the separated control unit. In addition, the numeric pad 92 may be replaced with any other type of input means as far as it is capable of specifying next slitting width and the number of slitting knives to be used next. For example, a touch-sensitive screen or wireless input means such as a mobile phone can be used. Also, the computer 94 may be replaced with a programmable logic controller of the slitter, a part of a production control computer of a production line, etc.

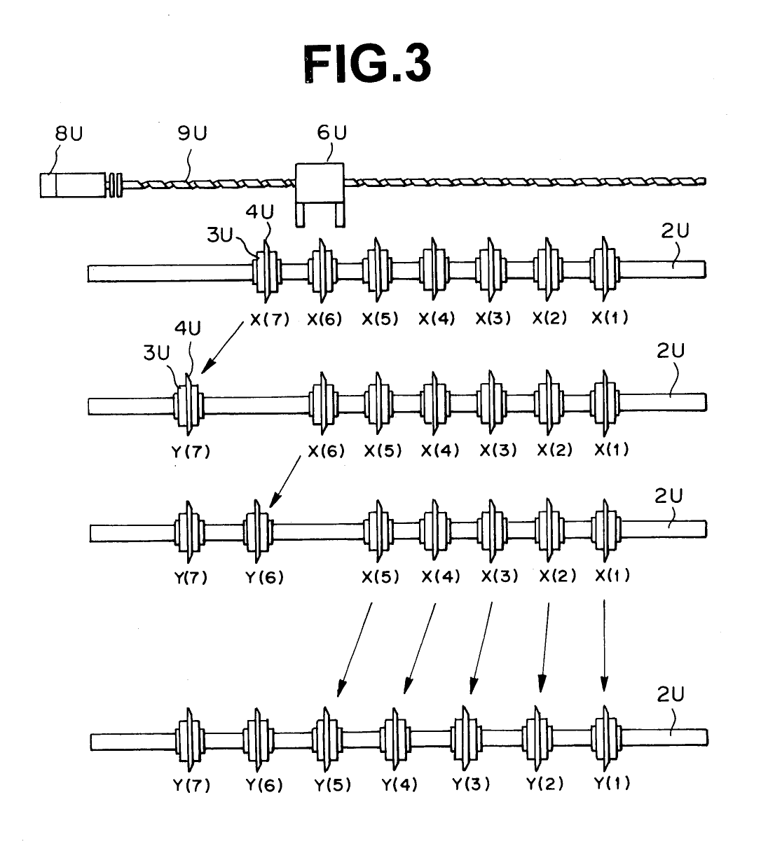

Though they will be described in detail later, the absolute positions X(N) and Y(N) are basically obtained in the following manner by use of the fixed common program. The absolute position X(N) can be given as a function of a knife ID number N, the current slitting width A, the next slitting width B and the number of knives currently used S1, X(N)=f{A, B, N, S1}, and the absolute position Y(N) can be given as a function of the knife ID number N, the current slitting width A, the next slitting width B and the number of knives to be used next S2, Y(N)=f{A, B, N, S2}. As described above, the next slitting width B and the number of knives to be used next S2 are input as input parameters by use of the numeric pad 92. Absolute positions X(N) and Y(N) are defined as distances from the left end of the upper shaft 2U as seen in FIG. 3. Accordingly, the position of the upper knife 4U is more rightward in FIG. 3 as the value of the absolute position X(N) or Y(N) increases.

The uppermost one of the upper shafts 2U shown in FIG. 3 shows the state where all the upper knives 4U are in position a and lowermost one of the upper shafts 2U shown in FIG. 3 shows the state where all the upper knives 4U are in position b. When the upper knives 4U are to be moved to position b from position a, the absolute positions X(N) and Y(N) are allocated to the blanks in the fixed format of program 20. Accordingly, the program 20 is converted as follows so that it specifies a series of signals for moving the upper knives 4U to respective positions that effect slitting with the next slitting width B and the number of knives S2 to be used next.

\mathring{1} To move the upper knife holder 3U in absolute position X(7) to absolute position Y(7).

\mathring{2} To move the upper knife holder 3U in absolute position X(6) to absolute position Y(6).

\mathring{3} To move the upper knife holder 3U in absolute position X(5) to absolute position Y(5).

\mathring{4} To move the upper knife holder 3U in absolute position X(4) to absolute position Y(4).

\mathring{5} To move the upper knife holder 3U in absolute position X(3) to absolute position Y(3).

\mathring{6} To move the upper knife holder 3U in absolute position X(2) to absolute position Y(2).

\mathring{7} To move the upper knife holder 3U in absolute position X(1) to absolute position Y(1).

When the program 20 converted as shown above is executed, the upper knife holder 3U (upper knife 4U) in absolute position X(7) is moved to absolute position Y(7) as shown by the second uppermost one of the upper shafts 2U shown in FIG. 3. Then the upper knife holder 3U in absolute position X(6) is moved to absolute position Y(6) as shown by the second lowermost one of the upper shafts 2U shown in FIG. 3. In the similar manner, the seven upper knife holders 3U are moved respectively to absolute positions Y(7) to Y(1) as shown by the lowermost one of the upper shafts 2U shown in FIG. 3.

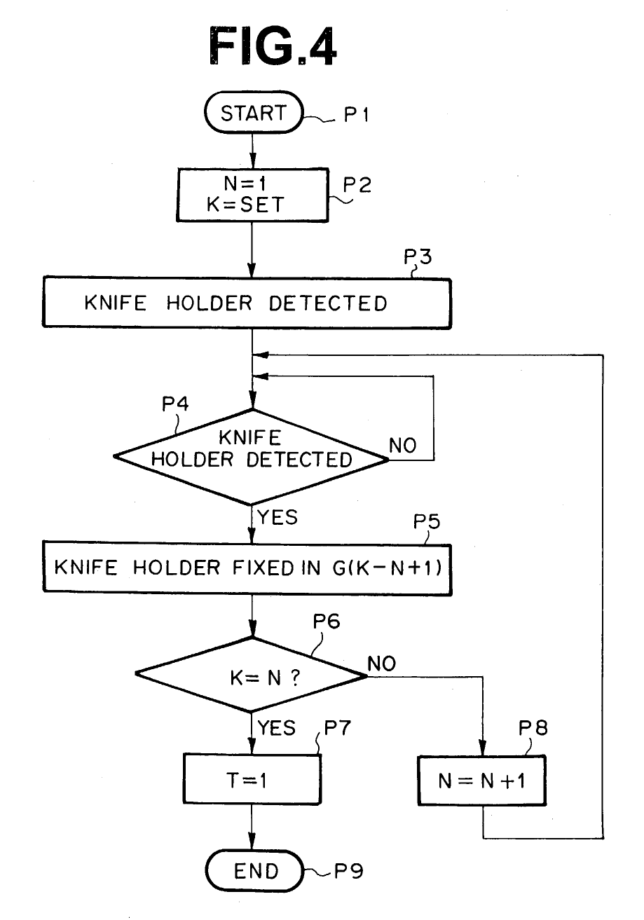

The fixed common program derives absolute positions X(1) to X(7) and Y(1) to Y(7) in the following manner. The following description will be made on a case where one or more of the seven upper knives 4 are sometimes not used in slitting. Initial position setting, that is, processing for setting all the upper knives 4U and 4L to the respective origin positions executed by the control unit 90 will be described first with reference to FIG. 4. The initial position setting for the lower knives 4L is the same as for the upper knives 4U and accordingly the following description is made only on the upper knives 4U.

The processing is started in step P1. Then a pointer N representing the ID number of an upper knife holder 3U is set to 1 and the number K of the upper knife holders 3U on the upper shaft 2U (seven in this particular embodiment) is set. (step P2) The upper knife holders 3U are detected one by one from the left side as seen in FIG. 3, by the holder detecting means 10U on the upper knife moving mechanism 6U. (step P3) The rightmost upper knife holder 3U as seen in FIG. 3 is kept stationary irrespective of the slitting width.

When one of the upper knife holders 3U is detected, the upper knife holder 3U is moved to origin position G(K−N+1) and fixed there by the upper knife moving mechanism 6U. (steps P4 and P5) K−N+1 stands for the ID number of origin position as numbered from the right side in FIG. 3. Steps P4 and P5 are repeated until N becomes equal to K with pointer N incremented each time step P5 is performed. (steps P6 and P8) In this manner, the upper knife holders 3U are moved to respective origin positions and fixed there one by one. When all the upper knife holders 3U are fixed to origin positions (K=N in step P6), flag T is set to 1, which represents that the positions of the upper knife holders 3U are initialized. (step P7) Then initialization is ended in step P9.

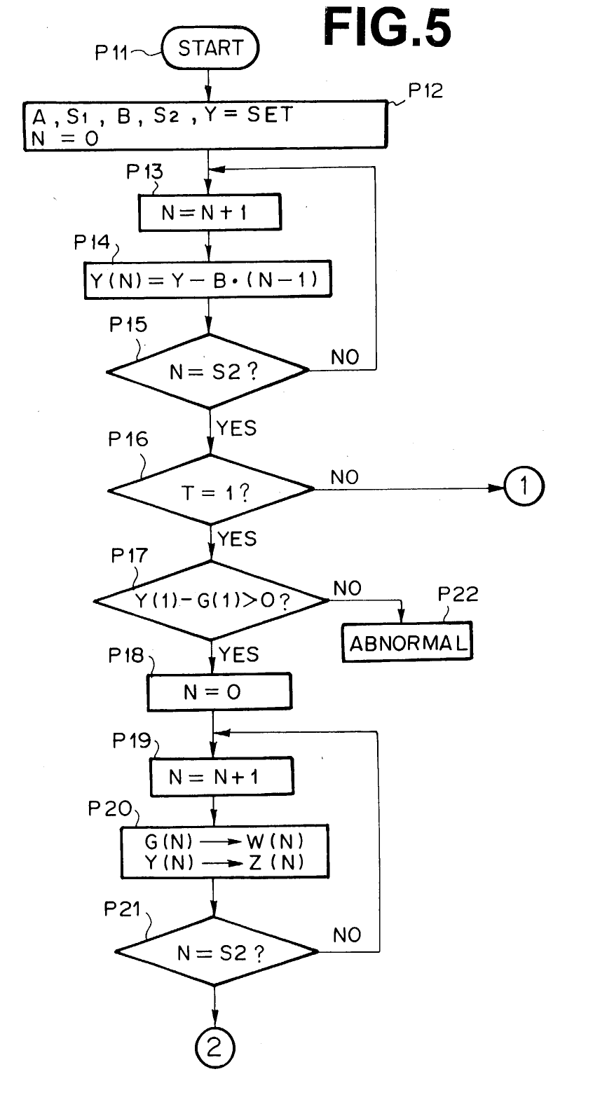

Processing after the initialization will be described with reference to FIGS. 5 to 8, hereinbelow. Processing is started in step P11 in FIG. 5. Then the current slitting width A, the number S1 of knives used for the current slitting width A, the next slitting width B, the number S2 of knives to be used for the next slitting width B and a reference position Y for the knives are set. Herein, the current slitting width A, the number S1 and the reference position Y are acquired from the memory 96 in the control unit 90. The next slitting width B and the number S2 are specified by use of the numeric pad 92. The pointer N representing the ID number of an upper knife holder 3U is set to 0. (step P12)

Herein, in the present embodiment, each of the motors 8U and 8L is equipped with an encoder that detects the position of the knife moving mechanism 6U or 6L on the threaded shaft 9U or 9L. During a set of movements for changing the slitting knife arrangement, the encoder detects each of the positions to which the knife moving mechanism 6U or 6L moves and fixes the knife holders 3U or 3L, and sends those positions to the memory 96. In the memory 96, those positions are recorded as the current positions of the slitting knives for the next set of movements. Preferably, the encoder is such a one that is capable of detecting absolute positions of the knife holders.

Then after pointer N is incremented by 1 in step P13, absolute position Y(N) of N−th upper knife holder 3U is obtained on the basis of the reference position Y and the next slitting width B. (step P14) Then it is determined whether N is equal to S2. (step P15) Thus steps P13 to P15 are repeated until N becomes to equal to S2, whereby absolute positions Y(N) for first to S2−th upper knife holders 3U are all obtained.

When it is determined in step P15 that N=S2, it is determined whether flag T=1 in step P16. When it is determined T=1, that is, when the upper knife holders 3U K in number are all fixed to their respective origin positions, it is determined whether Y(1)−G(1)>0 in order to check whether the system is in normal state. (step P17) When it is determined that Y(1)−G(1)<0, it is determined that the system in an abnormal state. (step P22) When it is determined in step P17 that Y(1)−G(1)>0, pointer N is set to 0 in step 18. Then pointer N is incremented by 1 in step P19 and origin positions G(N) and absolute positions Y(N) of first to S2−th upper knife holders 3U are allocated to program 20 as positions W(N) and Z(N) in sequence. (steps P19 to P21)

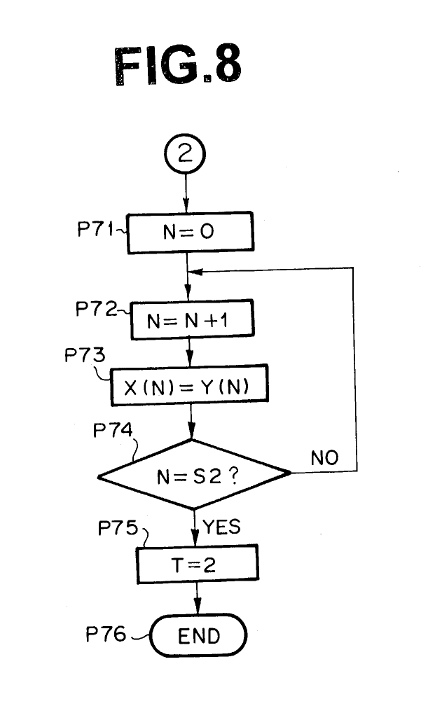

Then processing proceeds to step P71 shown in FIG. 8. In step P71, pointer N is set to 0. Then the absolute positions Y(N) of first to S2−th upper knife holders 3U are stored in the memory 96 in sequence as current absolute positions X(N) of first to S2−th upper knife holders 3U. (steps P72 to P74) Thereafter flag T is set to 2, which represents that the upper knife holders 3U are in predetermined positions. The knife position setting processing is ended in step P76.

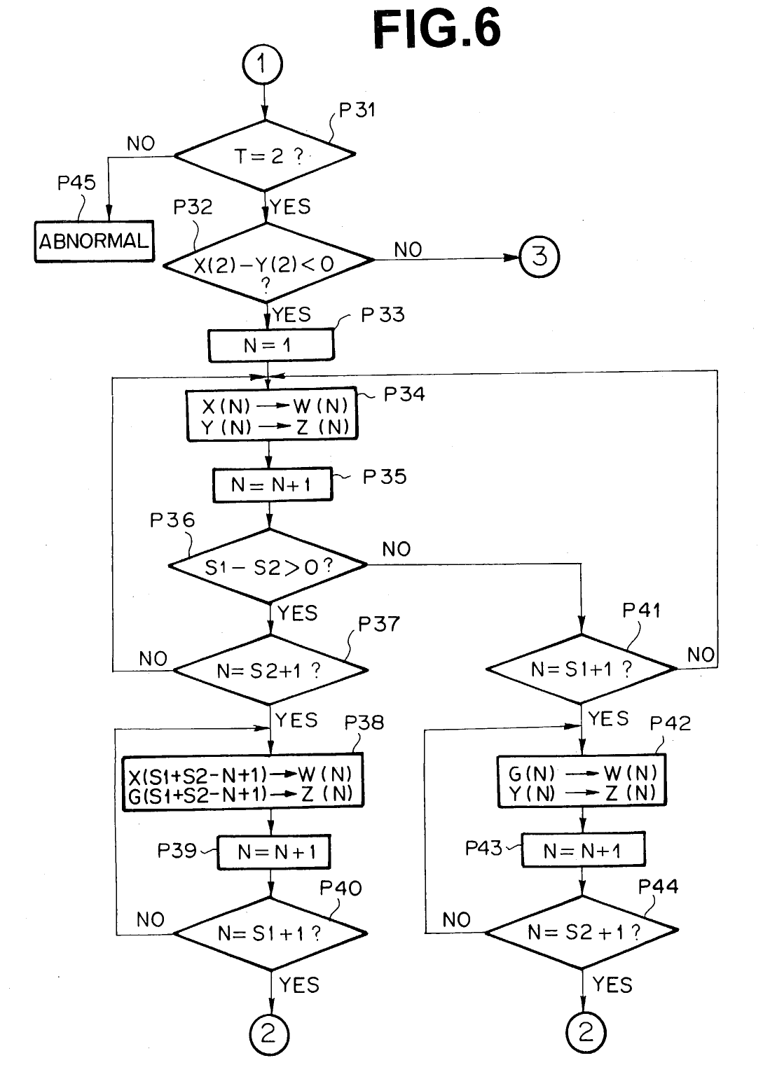

When it is determined that flag T is not 1 in step P16, processing proceeds to step P31 in FIG. 6. In step P31, it is determined whether flag T=2 and when it is determined that flag T is not 2, it is determined in step P45 that the system is in an abnormal state.

When it is determined that flag T is 2, that is, when it is determined that the upper knife holders 3U are in predetermined positions, it is determined whether X(2)−Y(2)<0. (step P32) When it is determined that X(2)−Y(2)<0, that is, in the case of switching where the slitting width is narrowed, pointer N is set to 1 in step P33 and absolute positions X(N) and Y(N) of a desired number of upper knife holders 3U are allocated to program 20 as positions W(N) and Z(N) in sequence in steps P34 and subsequent steps.

That is, absolute positions X(N) and Y(N) of a N−th upper knife holder 3U allocated to program 20 as positions W(N) and Z(N) in step P34 while incrementing pointer N by 1 in step P35 each time step P34 is performed. In the case of switching where the number of knives used is reduced, that is, S1−S2>0 (step P36), steps P34 and P35 are repeated until N becomes equal to S2+1 (step P37), whereby absolute positions X(N) and Y(N) of first to S2−th upper knife holders 3U are allocated to program 20 in sequence.

In the case of switching where the number of knives used is reduced, after absolute positions X(N) and Y(N) of first to S2−th upper knife holders 3U are allocated to program 20, absolute positions X(S1+S2−N+1) and origin positions G(S1+S2−N+1) of (S2+1)−th to S1−th upper knife holders 3U are allocated to program 20 as positions W(N) and Z(N) in sequence.

That is, absolute positions X(S1+S2−N+1) and origin positions G(S1+S2−N+1) of a (S1+S2−N+1)−th upper knife holder 3U are allocated to program 20 as positions W(N) and Z(N) in step P38 while incrementing pointer N by 1 in step P39 each time step P38 is performed. Steps P38 and P39 are repeated until N becomes equal to S1+1 (step P40), whereby absolute positions X(S1+S2−N+1) and origin positions G(S1+S2−N+1) of (S2+1)−th to S1−th upper knife holders 3U are allocated to program 20 in sequence.

Thereafter processing proceeds to step P71 shown in FIG. 8, and flag T is set to 2 in the manner described above, which represents that the upper knife holders 3U are in predetermined positions. The knife position setting processing is ended in step P76.

Thus, when the slitting width is to be narrowed and at the same time, the number of knives to be used is to be reduced from S1 to S2, first to S2−th upper knife holders 3U out of S1 upper knife holders 3U in the current position X(N) are moved to the respective next positions Y(N) in this order and S1−th to (S2+1)−th upper knife holders 3U are moved to the respective origin positions G(N) in this order. By employing this order, each of the upper knife holders 3U is moved to its desired position without being interfered by the others of the upper knife holders 3U.

In the case of switching where the number of knives used is increased, that is, when it is not determined that S1−S2>0 in step P36, steps P34 and P35 are repeated until N becomes equal to S1+1 (step P41), whereby absolute positions X(N) and Y(N) of first to S1−th upper knife holders 3U are all allocated to program 20 in sequence.

In the case of switching where the number of knives used is increased, after absolute positions X(N) and Y(N) of first to S1−th upper knife holders 3U are allocated to program 20, origin positions G(N) and absolute positions Y(N) of (S1+1)−th to S2−th upper knife holders 3U are allocated to program 20 as positions W(N) and Z(N) in sequence. (steps P42 to P44)

Thereafter processing proceeds to step P71 shown in FIG. 8, and flag T is set to 2 in the manner described above, which represents that the upper knife holders 3U are in predetermined positions. The knife position setting processing is ended in step P76.

Thus, when the slitting width is to be narrowed and at the same time, the number of knives to be used is to be increased from S1 to S2, first to S1−th upper knife holders 3U out of S1 upper knife holders 3U in the current position X(N) are moved to the respective next positions Y(N) in this order and (S1+1)−th to S2−th upper knife holders 3U in the respective origin positions G(N) are moved to the respective next positions Y(N) in this order. By employing this order, each of the upper knife holders 3U is moved to its desired position without being interfered by the others of the upper knife holders 3U.

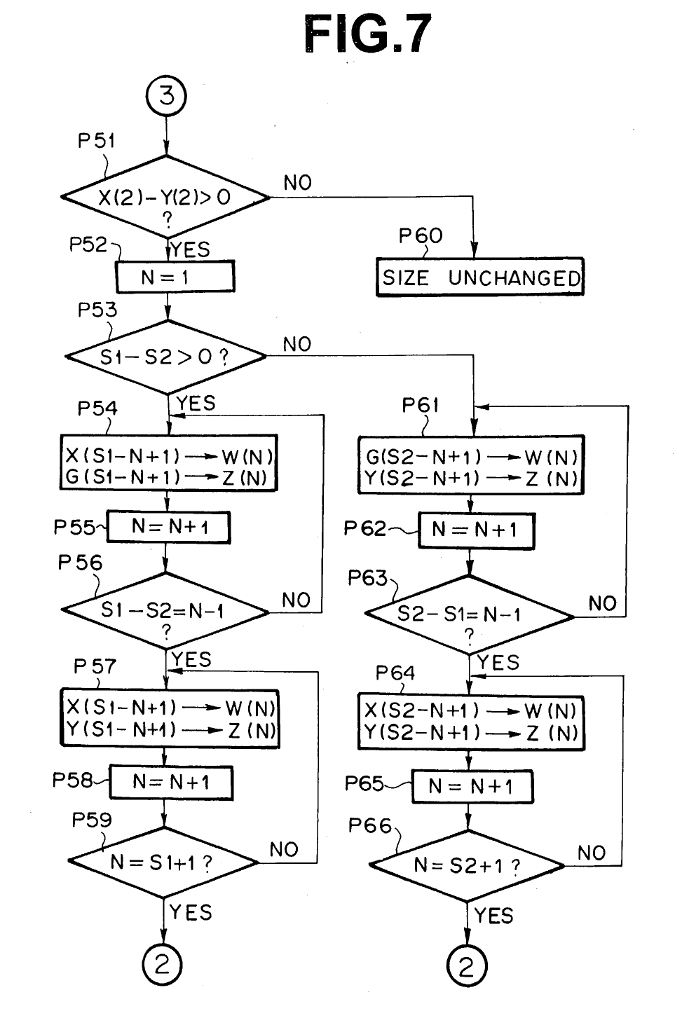

When it is determined in step P32 in FIG. 6 that X(2)−Y(2) is not smaller than 0, that is, in the case of switching where the slitting width is widened, processing proceeds to step P51 in FIG. 7. In step P51, it is determined whether X(2)−Y(2) is larger than 0. When it is determined that X(2)−Y(2) is not larger than 0, it is determined in step P60 that the slitting width is not changed.

When it is determined in step P51 that X(2)−Y(2) is larger than 0, pointer N is set to 1 in step P52 and then it is determined in step P53 whether S1−S2>0. When it is determined that S1−S2>0, that is, in the case of switching where the number of knives used is reduced, absolute position X(S1−N+1) and origin position G(S1−N+1) of a (S1−N+1)−th upper knife holder 3U, i.e., X(S1−N+1) and G(S1−N+1), are allocated to program 20 as positions W(N) and Z(N) in step P54 while incrementing pointer N by 1 in step P55 each time step P54 is performed. In the case of switching where the number of knives used is reduced, that is, S1−S2>0 (step P53), steps P54 and P55 are repeated until S1−S2 becomes equal to N−1 (step P56), whereby absolute positions X(N) and origin positions G(N) of S1−th to (S2+1)−th upper knife holders 3U are allocated to program 20 in sequence.

In the case of switching where the number of knives used is reduced, after absolute positions X(N) and origin positions G(N) of S1−th to (S2+1)−th upper knife holders 3U are allocated to program 20, absolute positions X(N) and Y(N) of S2−th to first upper knife holders 3U, i.e., X(S1−N+1) and Y(S1−N+1), are allocated to program 20 as positions W(N) and Z(N) in sequence.

That is, absolute positions X(S1−N+1) and Y(S1−N+1) of a (S1−N+1)−th upper knife holder 3U are allocated to program 20 as positions W(N) and Z(N) in step P57 while incrementing pointer N by 1 in step P58 each time step P57 is performed. Steps P57 and P58 are repeated until N becomes equal to S1+1 (step P59), whereby absolute positions X(N) and Y(N) of S2−th to first upper knife holders 3U are allocated to program 20 in sequence.

Thereafter processing proceeds to step P71 shown in FIG. 8, and flag T is set to 2 in the manner described above, which represents that the upper knife holders 3U are in predetermined positions. The knife position setting processing is ended in step P76.

Thus, when the slitting width is to be widened and at the same time, the number of knives to be used is to be reduced from S1 to S2, S1−th to (S2+1)−th upper knife holders 3U (S1−S2 in number) out of S1 upper knife holders 3U in the current position X(N) are moved to the respective origin positions G(N) in this order and S2−th to first upper knife holders 3U are moved to the respective next positions Y(N) in this order. By employing this order, each of the upper knife holders 3U is moved to its desired position without being interfered by the others of the upper knife holders 3U.

When it is determined in step P53 that S1−S2 is not larger than 0, that is, in the case of switching where the number of knives used is increased, origin position G(S1+N) and absolute position Y(S1+N) of a (S1+N)−th upper knife holder 3U, i.e., G(S1+N) and G(S1+N), are allocated to program 20 as positions W(N) and Z(N) in step P61 while incrementing pointer N by 1 in step P62 each time step P61 is performed. Steps P61 and P62 are repeated until S2−S1 becomes equal to N−1 (step P63), whereby origin positions G(N) and absolute positions Y(N) of (S1+1)−th to S2−th upper knife holders 3U are allocated to program 20 in sequence.

In the case of switching where the number of knives used is increased, after absolute origin positions G(N) and absolute positions Y(N) of (S1+1)−th to S2−th upper knife holders 3U are allocated to program 20, absolute positions X(N) and Y(N) of S1−th to first upper knife holders 3U, i.e., X(S2−N+1) and Y(S2−N+1), are allocated to program 20 as positions W(N) and Z(N) in sequence.

That is, absolute positions X(S2−N+1) and Y(S2−N+1) of a (S2−N+1)−th upper knife holder 3U are allocated to program 20 as positions W(N) and Z(N) in step P64 while incrementing pointer N by 1 in step P65 each time step P64 is performed. Steps P64 and P65 are repeated until N becomes equal to S2+1 (step P66), whereby absolute positions X(N) and Y(N) of S1−th to first upper knife holders 3U are allocated to program 20 in sequence.

Thereafter processing proceeds to step P71 shown in FIG. 8, and flag T is set to 2 in the manner described above, which represents that the upper knife holders 3U are in predetermined positions. The knife position setting processing is ended in step P76.

Thus, when the slitting width is to be widened and at the same time, the number of knives to be used is to be increased from S1 to S2, (S1+1)−th to S2−th upper knife holders 3U (S2−S1 in number) in the origin positions G(N) and S1−th to first upper knife holders 3U in the current positions X(N) are moved to the respective next positions Y(N) in this order. By employing this order, each of the upper knife holders 3U is moved to its desired position without being interfered by the others of the upper knife holders 3U.

In this embodiment, an additional arrangement of the slitting knives can be easily provided. That is, in this embodiment, an additional arrangement of the slitting knives can be provided by calculating positions to which the respective slitting knives are to be moved and order in which the slitting knives are moved without the necessity of revising the common program or creating new programs.

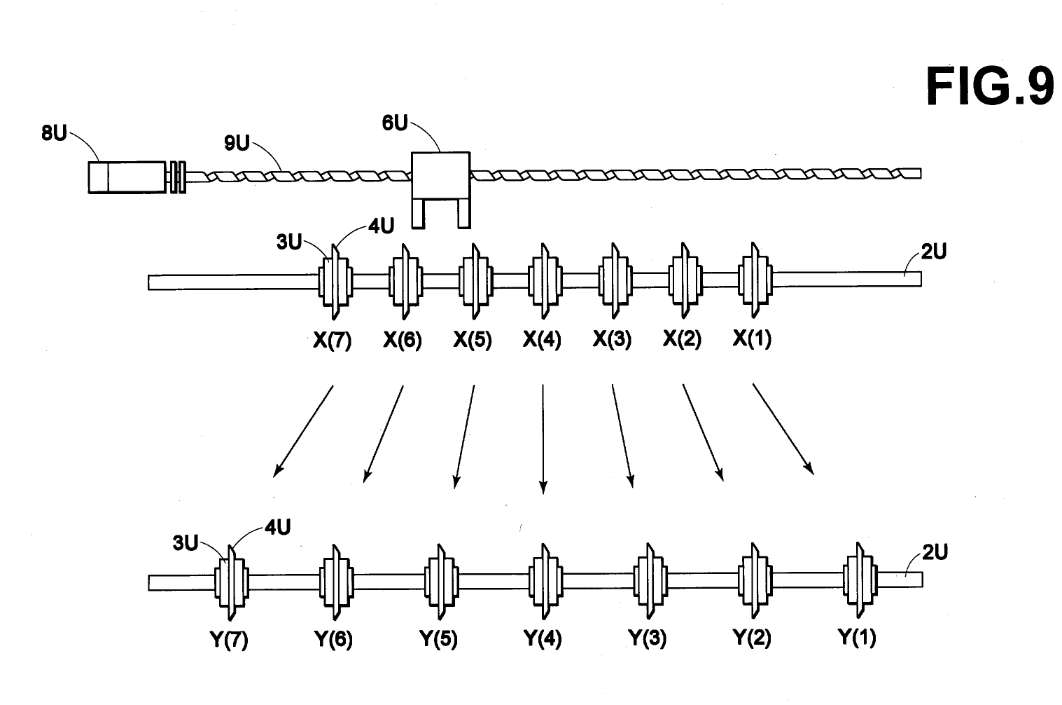

In addition, although described above is an embodiment that is applied to the mode where the rightmost slitting knife in FIG. 3 is fixed at the same position and all of the other slitting knives are moved in the same direction, it is obvious that those skilled in the art can easily modify the above embodiment into an alternative embodiment that is applied to a mode where the slitting knives are moved with respect to a reference point in the center of the slitting knife arrangement. Illustrated in FIG. 9 is an example of such a mode. When changing the slitting knife arrangement, the controller 90 checks the ID number of a slitting knife at which the sign of X(N)−Y(N) changes. In the illustrated case where there are seven slitting knives and the slitting width is to be widened while keeping the number of the knives to be used unchanged, X(N)−Y(N)<0 for N=1 to 3 and X(N)−Y(N)>0 for N=4 to 7. The calculation explained in above in reference to FIGS. 5-8 can be modified so that it is applied separately for the knives of N=1 to 3 and the knives of N=4 to 7, so that the knives of N=1 to 3 are moved from the one having a smaller ID number and the knives of N=4 to 7 are moved from the one having a larger ID number.

Further, in either of the modes illustrated in FIGS. 3 and 9, the entire pass rollers 1 and 5 carrying the wide sheet H can be moved in parallel after the slitting knife arrangement is changed, so that the center of the entire set of active slitting knives in use is matched with the center of the width of the wide sheet H.

What is claimed is:

1. A controller for controlling slitting knife arrangements in a slitter for slitting a wide sheet into a plurality of narrow strips by use of a plurality of slitting knives mounted on one or more shafts each extending in a direction substantially normal to a direction in which the wide sheet is fed, comprising:
input means for specifying a next slitting width and the number of slitting knives to be used next as input parameters; and
arithmetic means which receives said next slitting width and said number of slitting knives to be used next from the input means, and operates to generate a series of signals for moving said plurality of slitting knives to respective positions that effect slitting with said next slitting width and said number of slitting knives to be used next by use of a fixed common program.

2. A controller according to claim 1, wherein said series of signals are such signals that move said plurality of slitting knives in such an order that movement of each of said plurality of slitting knives is not interfered by the others of said plurality of slitting knives.

3. A controller according to claim 1, wherein said fixed common program is structured to generate said series of signals based on said next slitting width, said number of slitting knives to be used next, current positions of said plurality of slitting knives and the number of slitting knives currently used.

4. A controller according to claim 3, further comprising:
memory for storing said current positions of said plurality of slitting knives and said number of slitting knives currently used;
wherein said arithmetic means acquires said current positions of said plurality of slitting knives and said number of slitting knives currently used from said memory.

5. A controller according to claim 3, wherein said series of signals are such signals that move said plurality of slitting knives in such an order that movement of each of said plurality of slitting knives is not interfered by the others of said plurality of slitting knives.

6. A slitter for slitting a wide sheet into a plurality of narrow strips comprising:
a plurality of slitting knives mounted on one or more shafts each extending in a direction substantially normal to a direction in which the wide sheet is fed;
input means for specifying a next slitting width and the number of slitting knives to be used next as input parameters;
arithmetic means which receives said next slitting width and said number of slitting knives to be used next from the input means, and operates to generate a series of signals for moving said plurality of slitting knives to respective positions that effect slitting with said next slitting width and said number of slitting knives to be used next by use of a fixed common program; and
knife moving means for moving each of said plurality of slitting knives in the manner specified by said series of signals.

7. A method for controlling slitting knife arrangements in a slitter for slitting a wide sheet into a plurality of narrow strips by use of a plurality of slitting knives mounted on one or more shafts each extending in a direction substantially normal to a direction in which the wide sheet is fed, comprising the steps of:
specifying a next slitting width and the number of slitting knives to be used next as input parameters;
generating a series of signals for moving said plurality of slitting knives to respective positions that effect slitting with said next slitting width and said number of slitting knives to be used next by use of a fixed common program; and
moving each of said plurality of slitting knives in the manner specified by said series of signals.
